(19) United States
(12) Patent Application Publication
(10) Pub. No.: US 2018/0244510 A1
(43) Pub. Date: Aug. 30, 2018

(54) METHOD FOR ASEPTIC FILLING OF A CONTAINER, A STERILE FILLING DEVICE FOR SAID METHOD, AND AN ASEPTIC MACHINE

(71) Applicant: Indag Gesellschaft für Industriebedarf mbH & Co. Betriebs KG, Eppelheim (DE)

(72) Inventors: Rolf Harth, Neckargemünd (DE); Frank Lechert, Weinheim (DE)

(21) Appl. No.: 15/750,802

(22) PCT Filed: Aug. 5, 2016
(86) PCT No.: PCT/EP2016/068755

§ 371 Date: Feb. 6, 2018

(30) Foreign Application Priority Data
Aug. 7, 2015 (EP) 15180161.0

(51) Int. Cl. B67C 7/00; B65B 3/04; B65B 43/14; B65B 43/50; B65B 43/60; B65B 55/02; B65B 7/02

(52) U.S. Cl. CPC B67C 7/0086; B65B 3/045; B65B 43/14; B65B 43/50; B67C 2003/228; B65B 55/022; B65B 55/027; B65B 7/02; B65B 43/60

(57) ABSTRACT

The invention relates to a method for aseptic filling of a container with filling product, wherein the container is transported into an area of a sterile space assigned to the container, and then a mouth area of the container is then placed with a cap for filling in a mouth opening of the sterile space. The invention further relates to a sterile filling device for aseptic filling of a container, in particular for carrying out the stated method, with a sterile space which, in the bottom, comprises a mouth opening for a mouth area of a container and, in the lid, comprises a filling valve and a capper, wherein the filling valve or the capper can be brought into alignment with the mouth opening. Moreover, the invention relates to an aseptic machine with a carousel and, arranged on the latter, sterile filling devices which each have a sterile space, wherein an irradiating device is arranged in the periphery of the carousel for the purpose of irradiating at least the sterile filling device with electrons and/or X-rays prior to a filling operation.

### CROSS-REFERENCE TO RELATED APPLICATIONS

This application is a U.S. national stage entry of International Application No. PCT/EP2016/068755, filed Aug. 5, 2016, which claims priority to European Application No. 15180161.0, filed Aug. 7, 2015, the contents of both of which are incorporated by reference herein in their entirety.

### BACKGROUND OF THE INVENTION

### 1. Field of the Invention

The invention relates to methods for aseptic filling, a sterile filling device, and an aseptic machine.

### 2. Description of Related Art

It is known to provide, for preassembled packages, large sterile spaces to fill filling products into a container. It is difficult to maintain the sterile state of such large sterile spaces. After occurrence of a failure in which a loss of the sterile status of the sterile space is ascertained, it takes a long time until the large sterile space has again reached a sterile status so that the filling process may be resumed without promoting a secondary contamination of the container and/or the filling product.

### SUMMARY OF THE INVENTION

It is the object of the invention to provide a method for aseptic filling of a container, a sterile filling device and an aseptic machine, which allow efficient and safe aseptic filling of filling products into containers.

The object is solved by the methods, the sterile filling device, and the aseptic machine described herein. Preferred embodiments and variants are also disclosed.

In a method for aseptic filling a container with filling product, the container is transported into an area of the sterile space assigned to the container and subsequently a mouth area of the container with a cap for filling is placed in a mouth opening of the sterile space. This method allows a sterile space assigned to the contained to remain comparatively small, since only the mouth area of the container for filling is to be introduced into the sterile space. The container may represent a PET bottle or glass bottle with threading for a spout film bag.

The mouth opening of the sterile space may be, at most, 5% greater than the mouth area of the container. Moreover, it is advantageous when the shape of the mouth opening and the mouth area including the cap coincide at least approximately. For a circular-shaped cross section of the mouth area or the cap of the container, preferably the cross section of the mouth opening of the sterile space is also provided in a circular shape.

In the method for aseptic filling of a container, that portion of the container that does not belong to the mouth area is inserted into the sterile space. Therefore, solely the mouth area of the container is placed in the sterile space. The volume of the sterile space may, thus, be selected less compared to the sterile spaces of the prior art.

Preferably, for each container there is provided a corresponding sterile space. In case that a problem occurs during the filling process in the sterile space, thereby no longer guaranteeing the sterile status, it is sufficient to lock out only such containers that have been filled in this sterile space. Moreover, for resolving a failure, only the single sterile space having the problem has to be maintained or checked. In a filling machine comprising a plurality of sterile spaces for filling a plurality of containers, it may, thus, be guaranteed that the sterile spaces that have not shown any problems may be further used for the filling of containers. Consequently, it is not necessary to completely stop the filling machine.

The term “sterile space” relates to a space or a volume that may be brought into a sterile state. The sterile space does not need to be sterile at any time, but may be returned to or may be generally brought into a sterile state by a sterilizing procedure.

The method may be applied in the food industry for the filling of at least approximately liquid foods, such as beverages or pulp, and/or in the animal food industry for filling in at least approximately liquid foods, such as cat milk or canned food.

The sterile space and the mouth area of the container with a cap placed therein may be sterilized. After placing the mouth area within the mouth opening of the sterile space, the sterile space and the mouth area placed therein are sterilized such that a filling of the container filling product under aseptic or sterile conditions is accomplished. The sterilizing may be accomplished, for instance, by introducing a sterile gas into the sterile space and/or by externally applied irradiation with electron and/or X-rays.

The cap is removed after placing the mouth area in the mouth opening and prior to the filling process. In particular, during the filling of spout film bags, the spout film bags with applied cap are transferred into the sterile space or the mouth area is placed in the mouth opening in order to avoid contamination of the open spout film bag during transport of the spout film bag to the sterile space. The cap is then removed prior to filling the container. Prior to removing the cap, a capper may be provided in the sterile space, that is, a device configured to remove a cap from a mouth area of a container, for example, by grasping and subsequently twisting off the cap.

The container may be filled. The filling of the container may be accomplished by a filling valve positioned in the sterile space that may be aligned to the mouth opening of the sterile space and, thus, to the mouth area of the container.

After the filling process, the cap may be reattached to the mouth area of the container placed in the mouth opening. To this end, the capper positioned in the sterile space may be used. By reattaching the cap to the mouth area of the container, loss of the sterile status of the filled container may be avoided.

After the filling of a container and the reattachment of the cap, the mouth area of the container may again be removed from the mouth opening of the sterile space. In this manner, it is possible to use the filled containers for further operations.

A sterile filling device for aseptic filling of a container, in particular, for performing the method as discussed above or as described below, comprises a sterile space comprising at the bottom a mouth opening for a mouth area of a container and in the lid or cover, a filling valve or the capper may be aligned to the mouth opening.

To this end, it is contemplated that the mouth opening of the sterile space is, at most, greater by 5% than the mouth area of the container. Moreover, it is advantageous when the shapes of the mouth opening and the mouth area coincide at least approximately. With a round or circle-shaped cross section of the mouth area of the container, preferably the cross section of the mouth opening of the sterile is also shaped as a circle. Regarding the size of the mouth opening, it is additionally reasonable to consider whether or not the mouth area of the container comprises a cap/closure.

By means of the capper, the cap may be removed from the container, thereby enabling the filling of the container. After completing the filling process, this cap may be reattached to this container by means of the capper. The capper may be a device configured to remove or attach a cap from or to a mouth area of a container, for instance, by grasping the cap and twisting off or twisting on the cap.

The sterile space may further comprise a cleaning nozzle in the bottom that may be aligned to the filling valve. By means of the cleaning nozzle, the filling valve may be cleaned. Consequently, dried filling product residues, or upon changing the filling product, any residues of the previous product, may be removed during the cleaning process.

If the container is a spout film bag, the sealing device may be a retaining bracket of the spout film bag used to transport it into the area of the sterile space and for placing the mouth area, i.e., the spout, in the mouth opening of the sterile space.

If the container is a PET bottle or any other bottle with a threading, then a stopper of the mouth area may serve as a sealing device.

In these two exemplary cases, it may be further considered that external to the sterile space, at its bottom, a gasket ring or the like is provided so as to enclose the mouth opening and being adapted to be brought into contact with the mouth area for establishing a sterile condition.

The bottom and/or the lid may comprise an access or connection for sterile gas, for instance, H₂O₂. Since during placement of a mouth area of a container in the mouth opening of the sterile space or at and/or during the removal of the mouth area from the mouth opening, the sterile status of the sterile space may be no longer preserved due to contact with the environment, the sterile space is preferably (re-)sterilized prior to a filling process and/or prior to the removal of a cap of a container. This may be accomplished, for instance, by introducing sterile gas into the sterile space.

The sterile filling device may comprise a material that is transparent for electrons and/or X-rays in order to sterilize the sterile space. Since the sterile space and a mouth area of a container positioned therein are sterilized only, however, without a filling product to be filled in or a filling product already filled in, a sterilization may, thus, be accomplished by electron and/or X-rays. Consequently, it is advantageous for the material of the sterile filling device to be transparent for electrons and/or X-rays.

In the sterile space, an over pressure of at least 0.2 bar with respect to the environmental pressure may be established. By establishing an overpressure in the sterile space, the risk of contamination of the sterile space by penetrating environmental air may be reduced.

The bottom of the sterile space may be configured as stator and the lid or cover may be configured as rotor, wherein the rotor is configured to be rotatable with respect to the stator. In this manner, the filling valve positioned in the lid may be brought into alignment with the mouth opening positioned in the bottom so that a filling of the container, the mouth area of which is placed in the mouth opening, may be accomplished.

The rotor may be configured so as to be rotatable with respect to the stator around a rotation axis. This arrangement enables elements positioned in the lid, i.e., the rotor, to be aligned to elements positioned in the bottom, i.e., the stator, by rotation around the rotation axis. Since the container with its mouth area is disposed in the mouth opening positioned in the bottom, any unnecessary movement of the container during the filling process or also during a removal of a cap from the container is avoided.

The filling valve and/or the capper may be movable parallel to the rotation axis. This movability allows simple introduction of the filling valve into the mouth area of the container or placement of the filling valve above the mouth area in order to perform a filling process. After the filling process, the filling valve may be again removed from the mouth area by an upward movement. Moreover, in this case, it is possible that the filling valve may be removed out of the alignment with the mouth opening by a rotation of the rotor lid around the rotation axis.

The movability allows a capper, after being brought into alignment with the mouth opening or the mouth area, to be lowered in order to remove a cap from the container for a filling process or to reattach a cap to the container after a filling process.

The aseptic machine comprises a rotating carousel including, attached thereto, a plurality of sterile filling devices, each having a sterile space provided for aseptic filling of containers with a filling product, and including an irradiation apparatus positioned in the periphery of the rotating carousel for irradiating at least the sterile filling device with electrons and/or X-rays prior to a filling process.

The aseptic machine may be used in the food industry for filling at least approximately liquid foods, such as beverages or pulp, and/or in the animal food industry for filling of at least approximately liquid foods, such as cat milk or canned food.

The aseptic machine may further comprise an evaluation and control device for determining and evaluating state data of the sterile filling devices and for establishing and forwarding control data on the basis of the state data. The state data may comprise or relate to the negative pressure of the sterile space, the sterilizing of the sterile space and possibly of the spout film bag and/or the filling. During the evaluation, the state data determined may be compared to reference data in order to find out whether the state data match the reference data, meaning that the requirements of aseptic filling are met, or whether the entirety or a portion of the state data does not match the reference data, meaning that the requirements of an aseptic filling are at least partially not met. This reference data may be known to the evaluation and control device, but may also be input and/or read out from data storage.

Moreover, the aseptic machine may comprise at least one redirecting star for redirecting filled containers, the redirecting star being controllable by the control data. In this manner, it is possible to divert those containers that do not meet the required conditions of a sterile or aseptic handling, in particular, during the filling process.

To this end, a first one of the at least one redirecting star may be arranged to redirect filled containers to a printing device, a second one of the at least one redirecting star may be configured to switch or redirect filled containers to an output and/or a third one of the at least one redirecting star may be configured to divert filled containers. In this manner, it is possible for filled containers, after filling and closing procedures, to be treated differently depending on their associated state date of the corresponding sterile filling device, by diverting them differently.

A method for aseptic filling of containers in the aseptic machine as described above or described below comprises the steps: transporting the container into an area of a sterile space assigned to the container; placing the mouth area of the container in the mouth opening of the sterile space for filling; sterilizing the sterile space and the introduced mouth area; removing the cap after placing the mouth area in the mouth opening and prior to the filling.

The method may further comprise the following steps: aligning the filling valve with the mouth opening; moving the filling valve parallel to the rotation axis; inserting the filling valve into the mouth opening; filling the container with filling product; attaching the cap after the filling; removing the filling valve from the mouth opening and removing the mouth area from the mouth opening.

The method may further comprise the following steps: determining and evaluating state data of the sterile filling device and establishing and forwarding control data on the basis of the state data.

Moreover, the method may comprise at least one of the following steps: redirecting the filled container to a printing device; redirecting the filled container to an output; diverting the filled container.

### BRIEF DESCRIPTION OF THE DRAWINGS

For the purpose of a better understanding and visualization, the attached figures illustrate aspects of the present invention in an exemplary manner. In the figures:

FIG. 1 is a schematic side view of a first embodiment of a sterile filling device,

FIG. 2 is a schematic cross section of the first embodiment of the sterile filling device,

FIG. 3 is a flow chart of the method for aseptic filling of containers with a cap using the first embodiment of the sterile filling device,

FIG. 4 is a schematic view of an aseptic machine and

FIG. 5 is a flow chart of a method for redirecting a filled container.

### DETAILED DESCRIPTION OF THE INVENTION

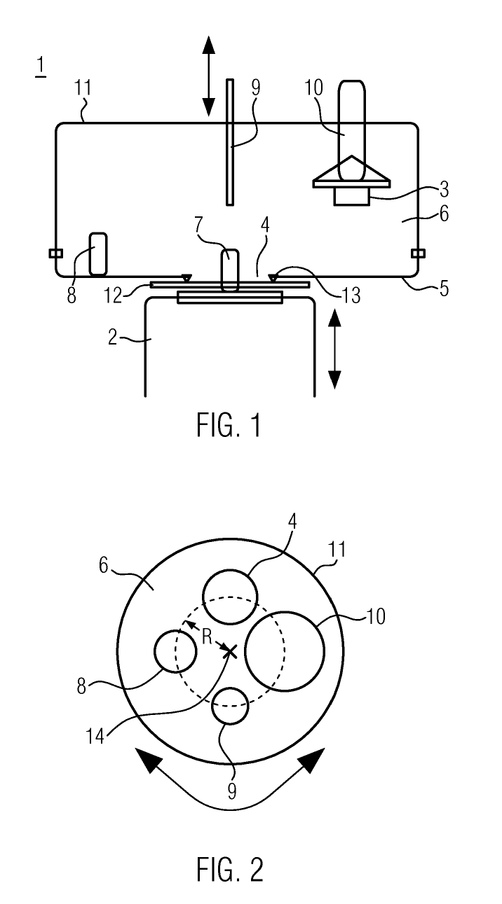

FIG. 1 shows a schematic side view of a first embodiment of a sterile filling device 1. This sterile filling device 1 is configured for filling spout film bags 2 including a cap 3. To this end, the mouth opening 4 in the bottom 5 of the sterile space 6, i.e., in the stator 5, is provided with a cap 3 for receiving the spout 7. Moreover, in the bottom 5, there is provided a cleaning nozzle 8 to be used for cleaning the filling valve 9 and the capper 10. The filling valve 9 and the capper 10 are provided in the lid 11 of the sterile space 6, that is, in the rotor 11. The filling valve 9, the mouth opening 4 and also the capper 10 are arranged such that the capper 10 and the filling valve 9 may be aligned with the mouth opening 4. The cleaning nozzle 8 is arranged so that it can be aligned with the filling valve 9 and the capper 10.

The rotor/lid 11 is arranged so as to be rotatable around a rotation axis 14 with respect to the stator/bottom 5 such that the capper 10 or the filling valve 9 may be positioned above the mouth opening 4, i.e., be aligned therewith. In this manner, a cap 3 of the spout film bag 2 may be subsequently removed by rotating the rotor/lid 11, the filling valve 9 may be positioned above the mouth opening 4 and by movement parallel to the rotation axis 14 it may be inserted into the mouth opening 4 and, thus, into the mouth area 7, so that the spout film bag 2 may be filled. Thereafter, by a movement parallel to the rotation axis 14, the filling valve 9 may be again removed from the mouth opening 4 or from the mouth area 7 and by a rotation of the rotor/lid 11, the capper 10 may be positioned above the mouth opening or the mouth area 7 so that the cap 3 may be attached to or put on the spout film bag 2.

A sealing of the sterile space 6 with respect to the environment is accomplished by a retaining bracket 12 together with a gasket ring 13 that is positioned outside the sterile space 6 at the bottom/stator 5.

FIG. 2 illustrates a schematic cross section of the first embodiment of the sterile filling device 1. In this embodiment, the filling valve 9, the mouth opening 4, the capper 10 and the cleaning nozzle 8 have a same radial distance R from the rotation axis 14. Therefore, it is possible by a rotation of the rotor/lid 11 relative to the stator/bottom 5 to stack these elements by rotation, i.e., to align these elements, so that a filling of the spout film bag 2 or a cleaning of the filling valve 9 or of the capper 10 may be accomplished.

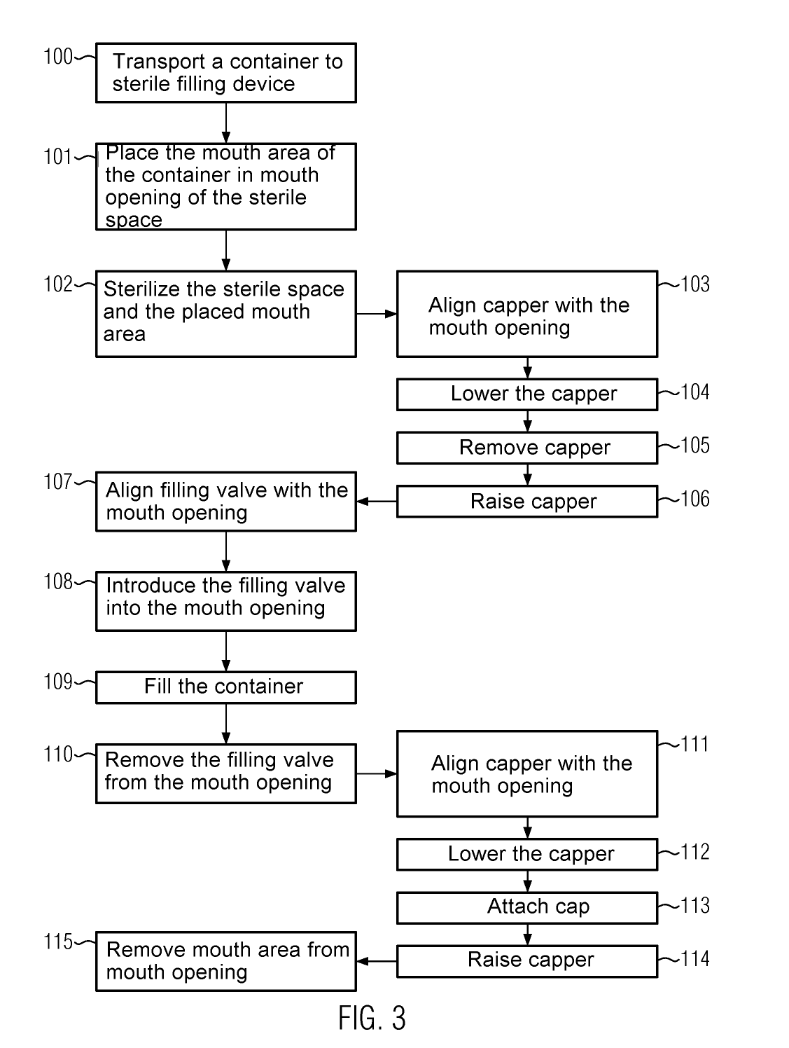

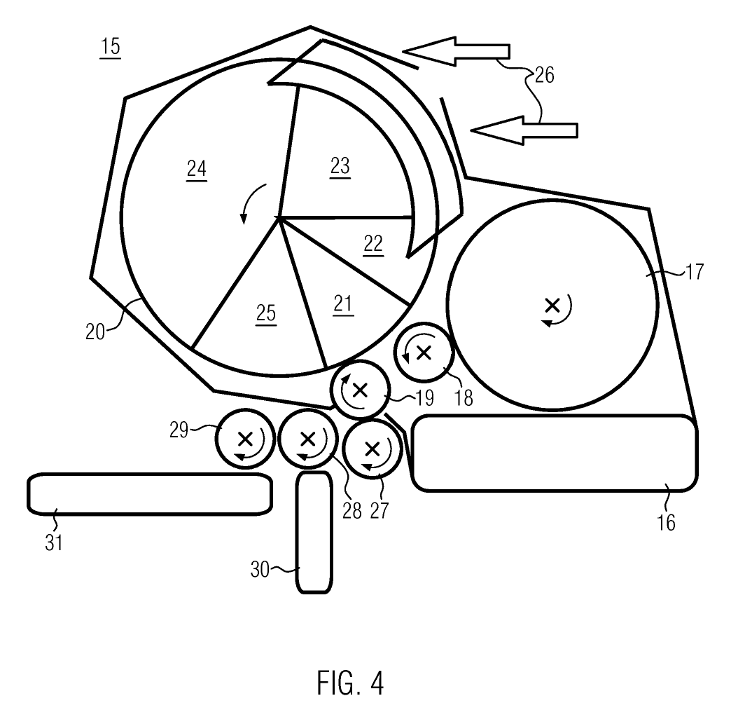

FIG. 3 shows a flow chart of a method for an aseptic filling of a container including a cap, such as the spout film bag, by using the first embodiment of the sterile filling device as described in FIGS. 1 and 2.

In step 100, the container is transported to the sterile filling device. For a spout film bag, a retaining bracket may be provided for this purpose, wherein the retaining bracket engages at an upper portion of the spout film bag. In step 101, the mouth area of the container is placed in the mouth opening of the sterile space of the sterile filling device. In step 102, the sterile space is sterilized, wherein the sterilization may be performed with sterile gas and/or with irradiation with electrons and X-rays.

In step 103, the capper is aligned with the mouth opening and, thus, with the mouth area. In step 104, the capper is lowered by moving it parallel to the rotation axis so that it is positioned such that the cap may be removed from the container. In step 105, the cap is removed from the container. In step 106, the capper is raised by a movement parallel to the rotation axis.

In step 107, the filling valve is aligned with the mouth opening and, thus, also with the mouth area of the container, wherein to this end, for instance, a rotation around the rotation axis is performed so as to rotate the lid with respect to the bottom or the rotor with respect to the stator of the sterile space.

In step 108, the filling valve is introduced into the mouth area of the container or the filling valve is positioned above the mouth area by a movement parallel to the rotation axis. In step 109, the container is filled with filling product. In step 110 the filling valve is removed from the mouth area of the container by a movement parallel to the rotation axis.

In step 111, the capper is aligned with the mouth opening and, thus, with the mouth area, which may be accomplished by performing a rotation around the rotation axis by rotating the lid with respect to the bottom or the rotor with respect to the stator of the sterile space. In step 112, the capper is lowered by a movement parallel to the rotation axis. In step 113, the cap is attached to the container. In step 114, the capper is raised by a movement parallel to the rotation axis.

In step 115, the mouth area of the container is removed from the mouth opening of the sterile space, which may be accomplished by, for instance, lowering downwardly the retaining bracket that holds the spout film bag. The filled container that is sealed by the cap may then be used for further operations.

FIG. 4 illustrates a schematic view of an aseptic machine 15 that is configured for establishing, filling and forwarding filled-up spout film bags. The film bags are provided in a magazine 16 from which the film bags are transferred to an apparatus 17 that shrink-wraps spouts in the film bags and attaches caps to the spouts.

In the illustrated embodiment of the aseptic machine 15, the spout film bags are transferred to a rotating carousel 20 by two redirecting stars 18, 19. A plurality of sterile filling devices that are not shown are arranged at the rotating carousel 20. The transfer of the spout film bags to the rotating carousel 20 is performed in a first area 21 of the rotating carousel 15.

Each spout film bag is associated with one sterile filling device, wherein in the bottom, the sterile filling device comprises a mouth opening for a mouth area, i.e., in this case, for the spout of the spout film bag, and comprises a filling valve in the lid, wherein the filling valve may be aligned with the mouth opening.

Placing the spout in the mouth opening and subsequently removing the cap are performed in a second area 22 of the carousel 15.

The sterile space of the sterile filling device together with the cap and the mouth area placed in the mouth opening is sterilized in a third area 23 of the carousel 20. At the same time, sterilizing that area of the spout film bag that is positioned outside the sterile space may also be performed. The sterilizing may be performed by means of electrons and/or X-rays emitted by an irradiation apparatus 26 positioned at the periphery of the rotating carousel 20.

Thereafter, the spout film bags are filled in a fourth area 24 of the rotating carousel 20 by means of the filling valve of the sterile filling device. After completion of the filling process, the cap is reattached to the spout film bag in this fourth area 24.

The mouth areas of the filled and sealed spout film bags are removed from the mouth openings of the sterile filling devices in a fifth area 25 of the rotating carousel 15.

In order to determine whether a filled and sealed spout film bag has been filled under conditions that meet the requirements of an aseptic filling in the food industry and/or animal food industry, state data may be required and evaluated by means of an evaluation and control device not shown, wherein the state data corresponds to a sterile filling device associated with the corresponding spout film bag. The state data may comprise the negative pressure in the sterile space, the sterilization of the sterile space and possibly also of the spout film bag and/or the filling process.

In an evaluation step, the state data may be compared with reference data in order to determine whether the state data match the reference data, meaning that the requirements of an aseptic filling are met or whether the entirety or a part of the state data does not match the reference data, meaning that the requirement of an aseptic filling are at least partially not met.

Based on the state data, the evaluation and control device may establish control data and may forward the control data to the redirecting stars 27, 28, 29 positioned downstream of the rotating carousel 20.

If the control data are based on the fact that the state data match the reference data, then the redirecting star 27 that directs or redirects the filled spout film bag to a printing device may be controlled, or the redirecting star 29 that directs or redirects the filled spout film to an output 31 may be controlled.

If the control data is based on the fact that the entirety or a part of the state data does not match the reference data, the redirecting star 28 may be controlled so as to redirect the filled spout film bag to a discharge point 30, thereby diverting this spout film bag.

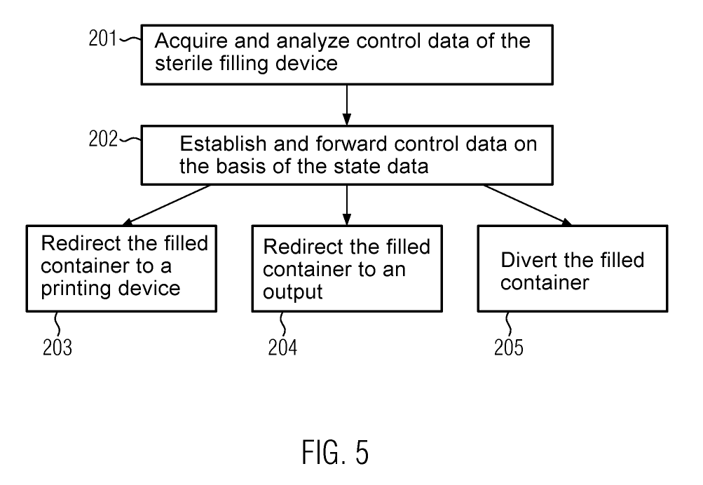

FIG. 5 shows a flow chart of a method for redirecting a filled container. A corresponding filled container may result from the method as illustrated in FIG. 3. In step 201, state data of the sterile film device is acquired or obtained and analyzed. The state data may comprise or relate to the negative pressure in the sterile space, the sterilization of the sterile space and possibly of the spout film bag and/or the filing process.

During the evaluation, the acquired state data may be compared with reference data in order to determine whether the state data match the reference data, meaning that the requirements of an aseptic filling are met, or whether the entirety or a part of the state data does not match the reference data, meaning that the requirements of an aseptic filling are at least partially not met. This reference data may be known to the evaluation and control device, however, this reference data may also be entered or read out from a data storage.

In step 202, control data are established and forwarded on the basis of the state data. In step 203, the filled container is redirected or directed to a printing device, for instance, when the control data are based on the fact that the state data match the reference data. Therefore, the redirecting star 27 may be controlled that then redirects the filled spout film bag to a printing device.

In step 204, the filled container is redirected to an output, for instance when the control data are based on the fact that the state data match the reference data. Accordingly, the redirecting star 29 may be controlled, which redirects the filled spout film bag to the output 31.

In step 205, the filled container is diverted, for instance, when the control data are based on the fact that the entirety or a part of the state data does not match the reference data. Accordingly, the redirecting star 28 may be controlled, which redirects the filled spout film bag to a discharge point 30, thereby diverting the spout film bag.

While there have been shown and described fundamental novel features of the invention as applied to the preferred and exemplary embodiments thereof, it will be understood that omissions and substitutions and changes in the form and details of the disclosed invention may be made by those skilled in the art without departing from the spirit of the invention. Moreover, as is readily apparent, numerous modifications and changes may readily occur to those skilled in the art. Hence, it is not desired to limit the invention to the exact construction and operation shown and described and, accordingly, all suitable modification equivalents may be resorted to falling within the scope of the invention as claimed. It is the intention, therefore, to be limited only as indicated by the scope of the claims appended hereto.

1. A method for aseptic filling of a container with filling product, characterized in that
a container is transported to an area of a sterile space that is assigned to the container and subsequently a mouth area of the container including a cap is placed in a mouth opening of the sterile space.

2. The method of claim 1, wherein the sterile space and the introduced mouth area including the cap are sterilized.

3. The method of claim 1, wherein after placing the mouth area in the mouth opening and prior to the filling, the cap is removed.

4. The method of claim 1, wherein the container is filled.

5. The method of claim 4, wherein after the filling, the cap is reattached to the mouth area placed in the mouth opening.

6. A sterile filling device for aseptically filling a container, in particular, for performing the method according to claim 1, including a sterile space that comprises in the bottom a mouth opening for a mouth area of the container and comprises in the lid a filling valve and a capper, wherein the filling valve and the capper, respectively, are configured to enable alignment with the mouth opening.

7. The sterile filling device of claim 6, wherein the bottom further comprises a cleaning nozzle that can be brought into alignment with the filling valve.

8. The sterile filling device of claim 6, wherein at least one of the bottom and the lid comprises an access for sterile gas.

9. The sterile filling device of claim 6, comprising a material that is transparent for at least one of electrons and X-rays for sterilizing the sterile space.

10. The sterile filling device of claim 6, wherein overpressure of 0.2 bar with respect to the ambient pressure is provided in the sterile space.

11. The sterile filling device of claim 6, wherein the bottom is configured as a stator and the lid is configured as a rotor, wherein the rotor is configured to be rotatable with respect to the stator, and wherein the rotor is preferably configured so as to be rotatable around a rotation axis with respect to the stator.

12. The sterile filling device of claim 11, wherein at least one of the filling valve and the capper is movable parallel to the rotation axis.

13. An aseptic machine with a rotating carousel characterized by
a plurality of sterile filling devices according to claim 6, each with a sterile space provided for aseptic filling of a container with filling product, and
an irradiation apparatus at the periphery of the rotating carousel for irradiating at least the sterile filling device with at least one of electrons and X-rays prior to performing a filling process.

14. The aseptic machine of claim 13, further comprising an evaluation and control device for acquiring and evaluating state data of the sterile filling devices and for establishing and forwarding control data on the basis of the state data.

15. The aseptic machine of claim 14, further comprising at least one redirecting star for redirecting filled containers, wherein the redirecting star is controllable by the control data.

16. The aseptic machine of claim 15, wherein a first one of the at least one redirecting star is configured to redirect a filled container to a printing device, a second one of the at least one redirecting star is configured to redirect a filled container to an output and/or a third one of the at least one redirecting star is configured to redirect a filled container to a discharge point.

17. A method for aseptic filling of a container in an aseptic machine of claim 13, the method comprising the steps:
transporting the container into an area of a sterile space, the area being assigned to the container,
placing the mouth area of the container in the mouth opening of the sterile space for filling,
sterilizing the sterile space and the introduced mouth area, after placing the mouth area in the mouth opening and prior to the filling, removing the cap,
aligning the filling valve with the mouth opening,
moving the filling valve parallel to the rotation axis,
introducing the filling valve into the mouth opening,
filling the container with filling product,
removing the filling valve from the mouth opening,
attaching the cap after the filling and
removing the mouth area from the mouth opening.

18. The method of claim 17, further comprising the steps:
acquiring and evaluating state data of the sterile filling device and
establishing and forwarding control data on the basis of the state data.

19. The method of claim 18, further comprising at least one of the following steps:
redirecting the filled container to a printing device,
redirecting the filled container to an output,
diverting the filled container.
